(19) United States
(12) Patent Application Publication
(10) Pub. No.: US 2008/0028896 A1
(43) Pub. Date: Feb. 7, 2008

(54) TOOL FOR USE WITH A GAS METER

(75) Inventor: Michael E. Natoli, Eureka, MO (US)

Correspondence Address: ZARLEY LAW FIRM P.L.C., CAPITAL SQUARE, 400 LOCUST, SUITE 200, DES MOINES, IA, 50309-2350, US

(73) Assignee: AME Technologies, LLC, Eureka, MO (US)

(21) Appl. No.: 11/462,764

(22) Filed: Aug. 7, 2006

(51) Int. Cl. B25B 13/06

(52) U.S. Cl. 81/121.1

(57) ABSTRACT

A tool for use with a as meter shut-off valve having an elongated member with a first end and a second end and a transverse or diagonal section extending between the first and the second end. Both the first end and the second end have a plurality of slots of differing shape and/or size adapted to receive the shut-off valve of the gas meter. The transverse section has a recess cut in both sides leaving a center wall.

### BACKGROUND OF THE INVENTION

This invention relates to a device for turning on and off a gas meter, and more specifically relates to a wrench adapted to receive a gas meter valve.

Gas meters are well-known in the art and generally have a shut-off valve that runs parallel to the gas pipe approximately 6 to 8 inches above the ground. To shut off the meter, typically an adjustable 10″ or 12″ wrench is used to grip the valve and turn the valve ¼ turn in either direction, until the valve is crosswise to the pipe.

While this method has worked, occasionally the valve can become stuck and the wrench provides insufficient leverage to move the valve. Therefore, a need exists in the art for a tool that addresses this problem.

An object of this invention is to provide a tool that provides additional leverage to turn a shut-off valve on a gas meter.

A further objective is to provide a tool for use with a gas meter that is economical to manufacture.

These and other objectives will be apparent to those skilled in the art based on the following written description.

### SUMMARY OF THE INVENTION

A tool for use with a as meter shut-off valve having an elongated member with a first end and a second end and a transverse or diagonal section extending between the first and the second end. Both the first end and the second end have a plurality of slots of differing shape and/or size adapted to receive the shut-off valve of the gas meter. The transverse section has a recess cut in both sides leaving a center wall.

### BRIEF DESCRIPTION OF THE DRAWINGS

FIG. 1 is a perspective of a tool and a gas meter;

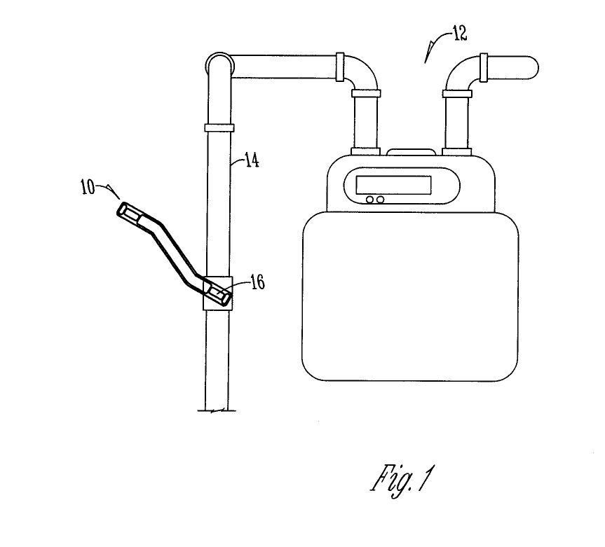

FIG. 2 is a perspective view of a tool for use with a gas meter; and

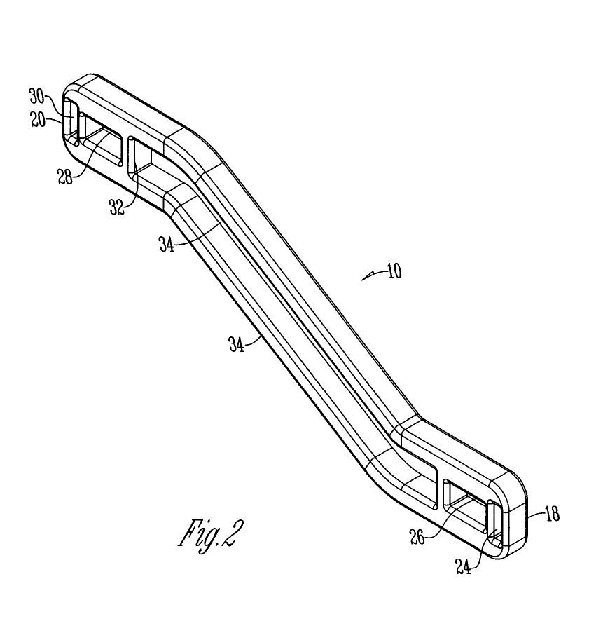

FIG. 3 is a side view of a tool for use with a gas meter.

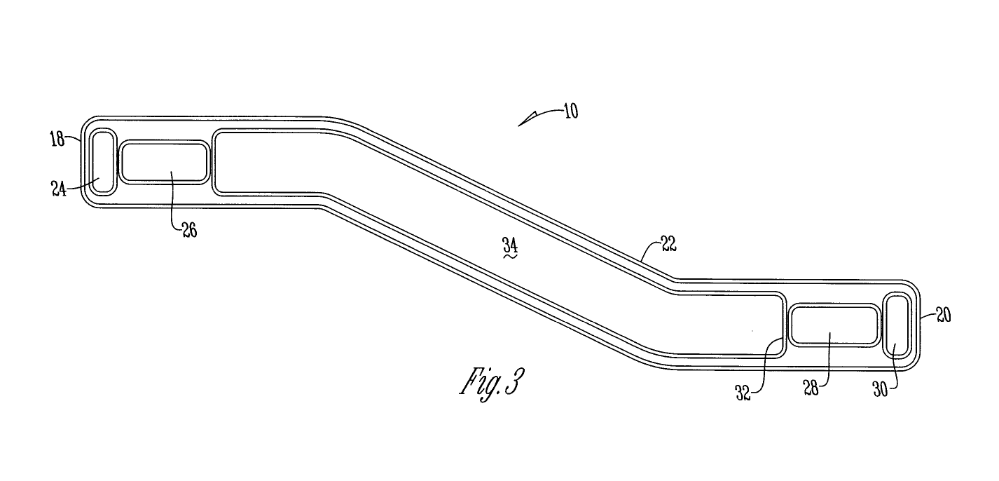

### DETAILED DESCRIPTION OF THE PREFERRED EMBODIMENT

Referring to the figures, the tool 10 is used with a gas meter 12 having a gas pipe 14 and a shut-off valve 16. The tool 10 has an elongated member 17 with a first end 18, a second end 20, and a transverse or diagonal section 22 that extends between the first end 18 and the second end 20.

The first end 18 has a plurality of slots 24 and 26 adapted to receive the shut-off valve 16. The second end 20, likewise, has a plurality of slots 28 and 30, fitted to receive the shut-off valve 16. While both ends show two rectangular slots, one in the art would understand that a single or multiple slots of any number and any shape can be used.

The transverse section 22 has a recess 32 on each side separated by a wall or partition 34. The recess reduces the weight of the tool, reduces the amount of material and cost of the tool, and provides a gripping edge when using the tool.

In operation, a slot (24, 26, 28, 30) of either end 18 or 20 is fitted over the shut-off valve 16. Once fitted the tool 10 is gripped at the opposite end and/or the recess 34 of the transverse section, and the tool 10 is moved until the shut-off valve 16 is turned a quarter turn. The angle created between the ends of the tool provide greater leverage in which to move the shut-off valve.

Thus, a tool for use with a shut-off valve of a gas meter has been shown that, at the very least meets all the stated objectives.

1. A tool for opening and closing a shut-off valve of a gas meter, comprising:
an elongated member having a first end, a second end, and a diagonal section that extends between the first end and the second end; and
wherein at least one end has at least one slot adapted to receive the shut-off valve.

2. The tool of claim 1 wherein both ends have at least one slot adapted to receive the shut off valve.

3. The tool of claim 1 wherein at least one end has a plurality of slots.

4. (canceled)

5. The tool of claim 1 wherein the diagonal section has a recess.
